(19) United States
(12) Patent Application Publication
(10) Pub. No.: US 2026/0208122 A1
(43) Pub. Date: Jul. 23, 2026

(54) Polyimide Membranes with Tunable Functionalization for Selective Removal of Per- and Polyfluoroalkyl Substances (PFAS)

(71) Applicant: Maoqi Mark Feng, Richland, WA (US)

(72) Inventor: Maoqi Mark Feng, Richland, WA (US)

(73) Assignee: Polykala Technologies, LLC, San Antonio, TX (US)

(21) Appl. No.: 19/570,845

(22) Filed: Mar. 18, 2026

(51) Int. Cl. B01D 69/02; B01D 65/02; B01D 67/00; B01D 71/64; B01J 39/04; B01J 39/19; B01J 41/04; B01J 41/13; B01J 43/00; B01J 47/127; B01J 49/53; B01J 49/57; C02F 1/44; C02F 101/36; C02F 103/06; C02F 103/10; C02F 103/34; C08J 5/22

(52) U.S. Cl. CPC B01D 69/02; B01D 65/02; B01D 67/00931; B01D 67/0095; B01D 71/64; B01J 39/04; B01J 39/19; B01J 41/04; B01J 41/13; B01J 43/00; B01J 47/127; B01J 49/53; B01J 49/57; C02F 1/44; C08J 5/2256; C08J 5/2287; B01D 2321/168; B01D 2323/39; B01D 2325/022; B01D 2325/42; C02F 2101/36; C02F 2101/40; C02F 2103/06; C02F 2103/10; C02F 2103/34; C02F 2303/16; C08J 2379/08

(57) ABSTRACT

A membrane and associated methods are provided for the selective removal of per- and polyfluoroalkyl substances (PFAS) from aqueous streams. The membrane comprises a polyimide polymer matrix functionalized with chemical groups disposed on the membrane surface, within pores, within the bulk polymer, or combinations thereof. The functional groups, which may include amines, quaternary ammonium groups, sulfonated polyimide domains, zwitterionic groups, or polydopamine coatings, impart preferential interaction with PFAS relative to inorganic anions. Methods of removing PFAS using the membrane, as well as methods for regenerating PFAS-loaded membranes using salt or alcohol-containing solutions, are also disclosed. A PFAS treatment system incorporating the membrane is further described. The membranes exhibit high PFAS rejection, low inorganic ion rejection, and maintain performance after repeated regeneration cycles.

### FIELD OF THE INVENTION

The present invention relates to membrane materials and separation systems for water treatment. More particularly, the invention relates to polyimide-based membranes having tunable chemical functionalization that enables selective removal of per- and polyfluoroalkyl substances (PFAS) from aqueous streams.

### STATEMENT REGARDING FEDERALLY SPONSORED RESEARCH

This invention was made with support from the U.S. Environmental Protection Agency under Contract Nos. 68HERD19C0016 and 68HERC20C0057.

### BACKGROUND OF THE INVENTION

Per- and polyfluoroalkyl substances (PFAS) have emerged as some of the most persistent and difficult-to-remove contaminants in modern water treatment. Their extreme chemical stability, mobility in the environment, and widespread use across industries and consumer applications has resulted in pervasive contamination of drinking water, groundwater, landfill leachate, and industrial wastewater. Conventional treatment technologies were not designed to address contaminants with the unique physicochemical properties of PFAS, and as a result, utilities face increasing challenges in achieving regulatory compliance.

PFAS removal is uniquely difficult due to the combination of strong carbon-fluorine bonds, hydrophobic and lipophobic fluorinated tails, and anionic headgroups. Short-chain PFAS are especially problematic: their high solubility and low hydrophobicity render them poorly captured by granular activated carbon (GAC) and only partially removed by many ion-exchange resins. High-pressure membrane processes such as reverse osmosis (RO) and nanofiltration (NF) can remove PFAS, but only at the cost of significant energy consumption, extensive pretreatment, and the generation of concentrated brine streams requiring further management.

Regulatory pressure continues to intensify. The U.S. Environmental Protection Agency (EPA) has proposed and finalized maximum contaminant levels (MCLs) for multiple PFAS compounds, including PFOA, PFOS, PFHxS, PFNA, HFPO-DA (GenX), and PFBS, with required detection limits in the parts-per-trillion range. These standards expose the limitations of existing technologies, many of which struggle to achieve consistent PFAS removal at such low concentrations, particularly in the presence of natural organic matter (NOM) and competing anions.

Existing PFAS treatment technologies suffer from fundamental shortcomings. GAC exhibits rapid breakthrough for short-chain PFAS and requires frequent replacement or energy-intensive thermal regeneration. Ion-exchange resins are sensitive to water chemistry and NOM, making performance unpredictable and often requiring costly pretreatment. RO and NF membranes remove PFAS but also reject nearly all dissolved ions, leading to excessive desalination, high operating pressures, and the production of large volumes of concentrated waste.

Critically, these technologies do not destroy PFAS; they merely transfer PFAS from water to another medium—spent carbon, spent resin, or membrane concentrate—creating secondary waste streams that are difficult and expensive to manage. Thermal destruction, hazardous waste landfilling, and emerging destructive technologies each present cost, scalability, or regulatory challenges, leaving utilities with few sustainable options.

Additional operational barriers further limit adoption. Many systems lack scalability for small or rural utilities, require specialized operators, or depend on laboratory-based PFAS analysis with long turnaround times. The absence of validated surrogate indicators or real-time monitoring tools makes it difficult to optimize treatment performance or anticipate breakthrough events.

Accordingly, there is a pressing need for PFAS treatment technologies that provide:
high selectivity for both long and short chain PFAS;
resistance to fouling by natural organic matter;
low energy consumption and low operating pressure;
regenerability to reduce lifecycle costs;
compatibility with downstream PFAS destruction processes;
modular, scalable system architectures; and
predictable performance across diverse water chemistries.

Conventional polymeric membranes lack chemical functionality tailored to the unique structure of PFAS. Their performance is governed primarily by size exclusion or charge repulsion, mechanisms that are insufficient for the broad range of PFAS encountered in real-world waters. As a result, traditional membranes exhibit limited PFAS affinity, poor selectivity, and rapid fouling in the presence of NOM.

The present invention addresses these long-standing deficiencies by providing polyimide-based membranes with tunable chemical functionalization that enables selective PFAS capture through engineered electrostatic, fluorophilic, and hydration-layer interactions. These membranes operate at low pressure, resist fouling, and can be regenerated using mild reagents-delivering unexpected and superior performance relative to conventional PFAS treatment technologies.

### SUMMARY OF THE INVENTION

The present invention relates to polyimide membranes, membrane systems, and associated regeneration processes engineered with tunable chemical functionalization for the selective removal of per- and polyfluoroalkyl substances (PFAS) from aqueous streams. As used herein, the terms “per- and polyfluoroalkyl substances” and “PFAS” are used interchangeably. The invention provides polyimide-based membranes whose PFAS affinity, selectivity, and fouling resistance are controlled through the type, density, and spatial distribution of functional groups incorporated on the membrane surface, within pore walls, or throughout the bulk polymer matrix. These functional groups impart preferential interaction with PFAS relative to inorganic anions, enabling high PFAS rejection under low-pressure operating conditions.

In one aspect, the invention provides polyimide membranes in which PFAS selectivity is governed by engineered functional groups that promote PFAS capture through electrostatic attraction, fluorophilic partitioning, molecular recognition, hydration-layer-mediated selectivity, or synergistic combinations thereof. Suitable functional groups include amines, quaternary ammonium groups, sulfonated polyimide domains, zwitterionic moieties, and dopamine-derived polydopamine coatings. These interactions enable high rejection of both long-chain and short-chain PFAS while maintaining low rejection of benign inorganic ions such as chloride, thereby providing superior separation performance compared to conventional membranes.

In another aspect, the invention provides membrane fabrication methods that include preparing a polyimide precursor solution using dianhydrides such as pyromellitic dianhydride (PMDA), 4,4′-(hexafluoroisopropylidene)diphthalic anhydride (6FDA), or benzophenone tetracarboxylic dianhydride (BTDA), and diamines including aromatic, sulfonated, or fluorinated species. The monomers are dissolved in N-methyl-2-pyrrolidone (NMP) to form a poly(amic acid) or polyimide solution suitable for membrane formation. Membranes may be produced through phase inversion, electrospinning, or thermal imidization to yield asymmetric structures with dense selective layers supported by porous substructures. These base membranes exhibit high chemical and thermal stability and serve as robust platforms for subsequent functionalization.

In an alternative aspect, the invention provides membrane functionalization methods that include surface activation using amine treatments (e.g., ethylenediamine) or dopamine-derived polydopamine coatings to introduce reactive sites. Functional groups may then be grafted or coupled to impart PFAS affinity, including quaternary ammonium groups for electrostatic attraction, sulfonated groups for fluorophilic partitioning, zwitterionic groups for hydration-layer-mediated antifouling, and diethylaminoethyl (DEAE) ligands for anion-exchange functionality. Polydopamine coatings may be formed by oxidative polymerization of dopamine under alkaline conditions, optionally using mixed water/THF solvents, pH adjustment with tris(hydroxymethyl)aminomethane, and aeration to promote uniform polymerization. Post-functionalization conditioning stabilizes the grafted or coated layers, producing membranes with tunable PFAS selectivity and high resistance to natural organic matter fouling.

In a further aspect, the invention provides PFAS removal processes in which feed water—such as drinking water, groundwater, landfill leachate, industrial wastewater, or mining-impacted water—is contacted with the functionalized membrane under low-pressure filtration (0.5-3 bar). PFAS molecules are selectively captured through electrostatic, fluorophilic, or hydration-layer-mediated interactions, producing a permeate with PFAS concentrations below 10 ng/L. The retentate stream contains concentrated PFAS suitable for downstream destruction or recovery. The membranes exhibit high PFOS and PFOA rejection while maintaining low rejection of inorganic anions, enabling energy-efficient PFAS remediation.

In certain aspects, the invention provides membrane regeneration methods that restore PFAS removal performance using mild reagents. Regeneration includes a salt rinse (0.1-1.0 M NaCl) to screen electrostatic interactions, an alcohol rinse (10-30% methanol or ethanol) to disrupt hydrophobic interactions with PFAS fluorinated tails, and a final water rinse to remove residual regenerant. This process maintains PFAS rejection within ±5% of initial performance, achieves greater than 95% flux recovery, and supports reliable multi-cycle operation. The regeneration process is compatible with both flat-sheet and nanofiber-based polyimide membranes.

In a preferred aspect, the invention provides an integrated PFAS treatment system comprising a feed tank, low-pressure pump, membrane module (flat-sheet, hollow fiber, or nanofiber), permeate outlet, and regeneration loop. The system supports continuous PFAS removal, automated regeneration cycles, and modular, scalable deployment. PFAS-concentrated retentate may be directed to destruction technologies such as supercritical water oxidation, plasma treatment, or electrochemical oxidation. The system enables sustainable PFAS management with low energy consumption, minimal waste generation, and compliance with EPA maximum contaminant levels.

### BRIEF DESCRIPTION OF THE DRAWINGS

The accompanying drawings illustrate exemplary embodiments of the invention and aid in understanding the structure, composition, and functionalization of the disclosed polyimide membranes and membrane systems. The drawings are provided for explanatory purposes only and are not intended to limit the scope of the invention.

FIG. 1 illustrates representative structure layout of polydopamine formed on top of polyimide substrate suitable for use in the membranes described herein, including exemplary dianhydride and diamine monomer units, in accordance with one embodiment of the invention.

FIG. 2 depicts another structure layout of polydopamine, formed on both sides of polyimide substrate through oxidative self-polymerization of dopamine under alkaline conditions, which serves as a versatile surface-functionalization layer for the polyimide membrane in certain embodiments.

FIG. 3 shows scanning electron microscopy (SEM) images of a polyimide membrane coated with polydopamine, demonstrating surface modification according to one embodiment of the invention.

FIG. 4 presents scanning electron microscopy images illustrating the formation of a uniform, conformal polymeric network on the membrane surface following the coating procedure, as described in embodiments of the invention.

### DETAILED DESCRIPTION OF THE INVENTION

The following detailed description provides exemplary embodiments of polyimide membranes, functionalized membrane systems, PFAS removal processes, and regeneration methods. These embodiments are illustrative and not limiting. Variations, equivalents, and modifications will be apparent to those skilled in the art.

The invention provides polyimide membranes and functionalized membrane systems engineered for the selective removal of per- and polyfluoroalkyl substances (PFAS) from aqueous streams. The membranes exhibit tunable chemical affinity, high chemical and thermal stability, and compatibility with low-pressure operation, enabling efficient PFAS capture, regeneration, and multi-cycle reuse. The following description details the fabrication of the polyimide membrane, the functionalization processes, PFAS removal mechanisms, regeneration protocols, and performance characteristics.

Fabrication of the polyimide membrane includes preparing a polyimide precursor solution, forming the membrane structure, and completing thermal imidization to obtain a chemically robust asymmetric membrane. Suitable dianhydrides include pyromellitic dianhydride (PMDA), 4,4′-(hexafluoroisopropylidene)diphthalic anhydride (6FDA), and benzophenone tetracarboxylic dianhydride (BTDA). Suitable diamines include aromatic, sulfonated, or fluorinated species. These monomers are dissolved in N-methyl-2-pyrrolidone (NMP) to form a poly(amic acid) or polyimide precursor solution with controlled viscosity and solids content.

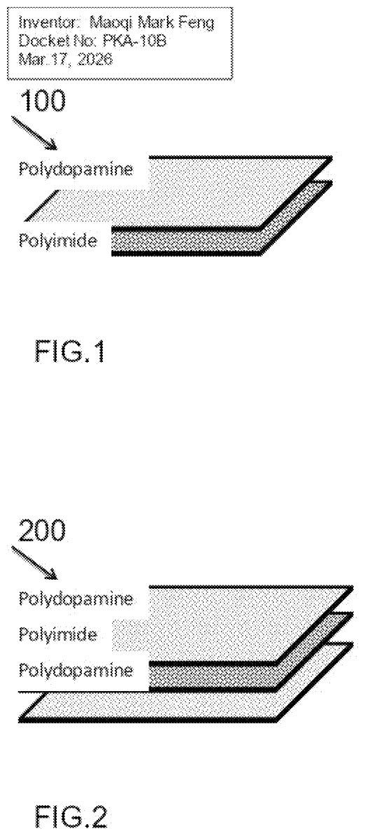

Membrane formation may be achieved through phase inversion, electrospinning, or direct thermal imidization. In a phase-inversion embodiment, the precursor solution is cast or extruded and immersed in a non-solvent bath to induce polymer precipitation and asymmetric pore formation. Subsequent thermal imidization converts the poly(amic acid) to polyimide, yielding a membrane with a dense selective layer supported by a porous substructure, as illustrated in FIG. 1. The resulting polyimide membrane exhibits high chemical stability, thermal resistance, and mechanical robustness suitable for downstream functionalization.

In one embodiment, the polyimide membrane is coated with a polydopamine layer using an alkaline dopamine polymerization process. Specifically, 1.0 g of dopamine hydrochloride is dissolved in 500 mL of a mixed solvent consisting of water and tetrahydrofuran (THF) in a 4:1 ratio. Subsequently, 0.6 g of tris(hydroxymethyl)aminomethane is added to adjust the solution to a pH of approximately 8.5. The membrane is fully submerged in the solution, and air is continuously bubbled through the mixture using a rubber tube to promote uniform polymerization. After approximately 12 hours, the solution darkens to a deep brown color, indicating formation of the polydopamine coating. The membrane is removed, rinsed thoroughly with deionized water, and dried in an oven at 40° C. for 12 hours. The resulting polydopamine-coated membrane exhibits a uniform surface layer, as shown in FIG. 2.

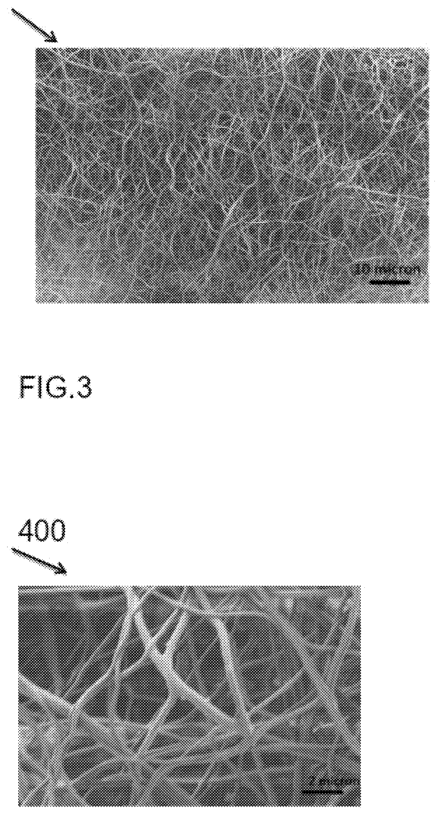

The morphology of the resulting polydopamine-coated membrane is illustrated in FIGS. 3 and 4. As shown in the SEM images, the coating forms a uniform, conformal polymeric network across the membrane surface and within the near-surface pore structure. The polydopamine layer exhibits nanoscale roughness and continuous coverage, confirming successful oxidative polymerization and deposition under the described alkaline conditions. This coating enhances surface reactivity and provides a stable platform for subsequent grafting of PFAS-affinity functional groups.

In one embodiment, the functionalization process begins with activation of the polyimide membrane surface to introduce reactive sites capable of supporting subsequent chemical modification. Surface activation may be achieved through amine treatment, such as exposure to ethylenediamine or other diamines, which introduces primary amine groups on the membrane surface and within pore walls. Alternatively, the membrane may be coated with dopamine under mildly alkaline conditions to form a conformal polydopamine layer rich in catechol and amine moieties. This layer, as shown in FIG. 2, provides a versatile platform for grafting functional groups through Michael addition, Schiff-base formation, or related coupling chemistries.

Following surface activation, functional groups are introduced to impart PFAS affinity, selectivity, or antifouling performance. Quaternary ammonium groups create permanent cationic sites that electrostatically attract anionic PFAS headgroups. Sulfonated groups grafted onto the polyimide backbone or onto the polydopamine layer form fluorophilic microphase-separated domains that enhance partitioning of PFAS fluorinated tails. Zwitterionic moieties such as sulfobetaines or carboxybetaines generate hydration layers that resist fouling by natural organic matter while maintaining PFAS selectivity. Diethylaminoethyl (DEAE) ligands may also be coupled to provide anion-exchange functionality. The type, density, and spatial distribution of these functional groups can be tuned to achieve targeted PFAS removal performance across diverse water matrices.

After attachment of the functional groups, the membrane undergoes conditioning to stabilize the functional layer and remove unreacted reagents. Conditioning may include sequential rinsing with water, buffer, or mild solvents to eliminate loosely bound species. In some embodiments, the membrane is equilibrated under controlled humidity or temperature to promote crosslinking, rearrangement, or consolidation of the functional layer. This step enhances membrane durability, minimizes leaching, and ensures consistent PFAS removal performance during filtration and regeneration cycles.

The resulting functionalized polyimide membrane exhibits tunable PFAS selectivity derived from engineered chemical interactions between the functional groups and PFAS molecules. The membrane maintains low rejection of benign inorganic ions and demonstrates strong resistance to fouling by natural organic matter. The membrane is compatible with low-pressure operation and can be regenerated using mild reagents, enabling sustainable multi-cycle PFAS treatment.

In one aspect, the PFAS removal process begins by introducing a feed stream-such as drinking water, groundwater, landfill leachate, or industrial wastewater-into the membrane module under low operating pressure, typically between 0.5 and 3 bar. The feed may contain long-chain and short-chain PFAS, inorganic ions, and natural organic matter, all of which influence membrane interactions.

As feed water contacts the functionalized membrane, PFAS molecules are selectively captured through engineered interactions. Quaternary ammonium groups attract anionic PFAS via electrostatic interactions. Sulfonated polyimide domains promote fluorophilic partitioning of PFAS fluorinated tails. Zwitterionic membranes rely on hydration-layer-mediated selectivity to resist fouling while maintaining PFAS rejection. These mechanisms may act independently or synergistically to provide high PFAS selectivity across diverse PFAS chemistries and water matrices.

The process produces a permeate stream with PFAS concentrations below 10 ng/L, meeting or exceeding regulatory limits. The membrane's engineered selectivity allows benign inorganic ions to pass through with minimal rejection, preserving water quality and reducing the need for remineralization. Permeate flux remains stable due to antifouling properties and low-pressure operation.

PFAS molecules rejected by the membrane accumulate in the retentate stream, forming a concentrated PFAS solution suitable for downstream destruction or recovery. The retentate may be directed to supercritical water oxidation, plasma treatment, electrochemical oxidation, or other PFAS destruction technologies. Concentrating PFAS into a small-volume stream reduces disposal costs and environmental impact.

Regeneration begins with a salt rinse using 0.1-1.0 M sodium chloride. The elevated ionic strength screens electrostatic interactions between anionic PFAS headgroups and cationic membrane sites, promoting desorption of PFAS bound through charge-based mechanisms. This step is particularly effective for quaternary ammonium-or DEAE-functionalized membranes.

The membrane is then exposed to an alcohol rinse containing 10-30% methanol or ethanol. The alcohol disrupts hydrophobic interactions between PFAS fluorinated tails and fluorophilic or hydrophobic membrane domains, enhancing removal of both long-chain and short-chain PFAS species.

A final water rinse removes residual salt, alcohol, and desorbed PFAS molecules from the membrane surface and pore structure. This rinse restores the membrane to a neutral state and prepares it for subsequent filtration cycles.

The regeneration cycle restores membrane performance to near-initial levels, with PFAS rejection maintained within ±5% of the original value and flux recovery exceeding 95%. The mild reagents prevent degradation of functional groups or the polyimide backbone, enabling reliable multi-cycle operation and reducing long-term treatment costs.

The membranes remove a broad range of PFAS, including PFOS, PFOA, PFHxS, PFNA, PFHpA, PFBS, and hexafluoropropylene oxide dimer acid (GenX), as well as other perfluoroalkyl carboxylates and sulfonates with chain lengths from C3-C14.

Quaternary ammonium groups impart a permanent positive charge, enabling strong electrostatic attraction to anionic PFAS. These membranes exhibit high rejection of long-chain PFAS due to combined electrostatic and hydrophobic effects.

Sulfonated polyimides incorporate—SO₃H groups into the polymer backbone, inducing microphase separation and forming fluorophilic domains. These membranes exhibit chain-length-dependent selectivity favoring long-chain PFAS.

Zwitterionic groups such as sulfobetaines and carboxybetaines generate hydration layers that suppress fouling by natural organic matter while maintaining moderate PFAS rejection and low inorganic ion rejection. PFAS penetrate hydration layers due to interactions between their fluorinated tails and the membrane's functional domains.

### EXAMPLES

The following examples illustrate embodiments of the invention and are not intended to limit the scope of the claims. All percentages are by weight unless otherwise indicated.

### Example 1—Electrospun Polyimide Nanofiber Mats for PFAS Removal

Two electrospun polyimide nanofiber mats (8.5 in ×15.5 in) were fabricated, exhibiting an average thickness of 61.1±2.6 μm. SEM imaging confirmed uniform nanofiber morphology and high porosity. Wastewater was pumped through the mats at a flow rate of 15 mL/min for 1 hour. No detectable fluorine was observed in the treated water, demonstrating complete PFAS removal under the tested conditions.

### Example 2—Cationic Polyimide Membrane Functionalized with Quaternary Ammonium Groups

A polyimide membrane was cast from a 15 wt % solution in NMP, activated with ethylenediamine, and subsequently quaternized using methyl iodide. Following functionalization, the membrane zeta potential shifted from −18 mV to +32 mV, confirming successful introduction of permanent cationic sites.

In crossflow filtration of a 200 ng/L mixture of PFOA and PFOS:
PFOS rejection: >90%
PFOA rejection: >90%
Chloride rejection: <25%

These results demonstrate strong electrostatic PFAS affinity with minimal rejection of benign inorganic ions. Wastewater was pumped through the mats at 15 mL/min for 1 hour. No detectable fluorine was observed in the treated water.

### Example 3—Zwitterionic-Functionalized Polyimide Membrane

A 14 wt % polyimide membrane was cast and surface-activated with ethylenediamine, followed by grafting of sulfobetaine methacrylate to introduce zwitterionic functionality. The water contact angle decreased from 78° to 32°, and the zeta potential remained near-neutral, indicating formation of a hydration-layer-forming surface.

In synthetic drinking water:
PFOS rejection: ≥85%
PFOA rejection: ≥85%
PFHxS rejection: ≥80%
Chloride/bicarbonate rejection: <20%
Flux decline over 72 hours: <5%

The membrane exhibited strong antifouling performance and selective PFAS removal.

### Example 4—Sulfonated Polyimide Membrane for Chain-Length-Selective PFAS Removal

A sulfonated polyimide was synthesized using ODADS and 6FDA, chemically imidized, and cast into an asymmetric membrane. The resulting membrane exhibited a water uptake of 38% and a zeta potential of −22 mV at pH 7.

PFAS rejection results demonstrated chain-length-dependent selectivity:
PFOS (C8): 90%
PFOA (C7): 82%
PFHxA (C6): 55%
PFBA (C4): 28%

These results confirm that fluorophilic microphase-separated domains preferentially retain long-chain PFAS.

### Example 5—Regeneration of Functionalized Polyimide Membranes

A quaternary-ammonium-functionalized membrane was loaded with PFOS and PFOA during 8 hours of filtration. Regeneration was performed using:
0.5 M NaCl at pH 10
20% methanol-water rinse

The regeneration protocol achieved:
95% PFAS recovery
No loss in zeta potential
PFAS rejection maintained within ±5% after 10 cycles

These results demonstrate robust multi-cycle performance and chemical stability of the functionalized membrane.

### Example 6—Integrated PFAS Treatment System Using Functionalized Polyimide Membranes

A modular treatment system containing three functionalized polyimide membranes (0.1 m² each) was operated at 1.5 bar for 7 days. The feed water contained PFOS, PFOA, PFHxS, inorganic ions, and humic acid.

System performance:
PFAS removal: >90%
Permeate PFAS concentration: <10 ng/L
Chloride rejection: <20%
Flux decline: <8%

Automated regeneration every 48 hours restored >95% of initial flux, demonstrating system-level stability and scalability.

Table 1 summarizes the PFAS selectivity and fouling behavior of polyimide membranes functionalized with different chemical groups. Unfunctionalized polyimide exhibits limited PFAS rejection and high susceptibility to natural organic matter (NOM) fouling. Quaternary ammonium functionalization provides the highest PFOS and PFOA rejection with minimal chloride rejection. Sulfonated polyimide demonstrates chain-length-dependent PFAS selectivity with moderate inorganic ion rejection. Zwitterionic functionalization yields balanced PFAS rejection, low inorganic ion rejection, and the lowest NOM fouling among the tested membranes.

TABLE 1
PFAS Selectivity as a Function of Functionalization

| | PFOS | PFOA | Cl⁻ | NOM |
|---|---|---|---|---|
| Functionalization Type | Rejection | Rejection | Rejection | Fouling |
| Unfunctionalized | 45% | 40% | 15% | High |
| Polyimide (PI) | | | | |
| Quaternary Ammonium | 92% | 89% | 20% | Moderate |
| Functionalization | | | | |
| Sulfonated Polyimide | 88% | 75% | 35% | Moderate |
| Zwitterionic Polyimide | 82% | 80% | 25% | Low |

### Comparative Examples

The following comparative examples evaluate the performance of conventional PFAS treatment technologies relative to the functionalized polyimide membranes described herein. These examples are provided for illustration and are not intended to limit the scope of the invention.

### Comparative Example a—Performance of Commercial RO and NF Membranes for PFAS Removal

A commercial thin-film composite reverse osmosis (RO) membrane and a commercial nanofiltration (NF) membrane were evaluated under conditions identical to those used for the functionalized polyimide membranes in Examples 2-6. The feed water contained 100 ng/L each of PFOS, PFOA, and PFHxS, along with 2 mM bicarbonate, 1 mM chloride and 5 mg/L humic acid at pH 7.5. The RO membrane was operated at 10.3 bars and the NF membrane at 6.9 bars.

Performance results are summarized in Table A1.

TABLE A1
RO/NF PFAS Removal and Fouling Performance

| Membrane | PFOS | PFOA | PFHxS | Cl⁻ Rejection | Decline |
|---|---|---|---|---|---|
| Type | Rejection | Rejection | Rejection | Flux | (72 h) |
| RO | >99% | >98% | >95% | >95% | 35% |
| NF | 90% | 82% | 60% | 70% | 28% |

These results show that while RO and NF membranes provide high PFAS rejection, they require significantly higher operating pressures and exhibit substantial flux decline due to fouling.

### Comparative Example B—Performance of Granular Activated Carbon (GAC) for PFAS Removal

A commercial bituminous-based granular activated carbon (GAC) was tested in a fixed-bed column (bed depth 20 cm, EBCT=10 minutes) using the same feed water composition as in Examples 3 and 6.

Breakthrough curves showed:
PFOS breakthrough (C/C₀=0.1): ~4,500 bed volumes
PFOA breakthrough (C/C₀=0.1): ~1,200 bed volumes
PFHxS breakthrough (C/C₀=0.1): ~800 bed volumes
Short-chain PFAS (PFBA, PFBS): negligible removal

Regeneration required thermal treatment at 800° C., resulting in:
Carbon loss of 8-12% per cycle
High energy consumption
PFAS volatilization requiring off-gas treatment

These results demonstrate that GAC exhibits limited removal of short-chain PFAS, rapid breakthrough for PFOA and PFHxS, and costly, destructive regeneration requirements. In contrast, the functionalized polyimide membranes described herein provide high PFAS selectivity, mild regeneration, and stable multi-cycle performance.

### Comparative Example C—Side-by-Side Pilot Test: Functionalized Polyimide Vs. RO Vs. GAC

A 14-day pilot study was conducted using three parallel treatment trains:
Train 1: Quaternary-ammonium-functionalized polyimide membrane (Example 2)
Train 2: Commercial RO membrane
Train 3: GAG column

The feed water contained 150 ng/L PFOS, 150 ng/L PFOA, 100 ng/L PFHxS, 5 mg/L humic acid, 2 mM bicarbonate, and 1 mM chloride.

TABLE C1
Side-by-Side Pilot Comparison

| | Functionalized | | |
|---|---|---|---|
| Metric | PI | RO | GAC |
| PFOS removal | 92% | >99% | 85% (breakthrough |
| | | | day 10) |
| PFOA removal | 89% | >98% | 60% (breakthrough |
| | | | day 6) |
| PFHxS removal | 82% | 95% | 40% |
| Chloride rejection | | >95% | 0% |
| Operating pressure | 1.5 bar | 10.3 bar | N/A |
| Energy | Low | High | Low |
| consumption | | | |
| Fouling (flux | | 35% | N/A |
| decline) | | | |
| Regeneration | Mild salt/alcohol | Chemical | Thermal |
| | | cleaning | (800° C.) |

The functionalized polyimide membrane demonstrated:
High PFAS selectivity
Low energy consumption
Minimal salt rejection
Superior fouling resistance
Simple, low-cost regeneration

RO provided high PFAS removal but required high operating pressure and caused excessive desalination. GAC exhibited rapid breakthrough and poor performance for short-chain PFAS.

These comparative results demonstrate that the functionalized polyimide membranes described herein provide unexpected and superior performance relative to conventional PFAS treatment technologies.

1. A membrane for selective removal of per- and polyfluoroalkyl substances (PFAS) from an aqueous stream, the membrane comprising:
a polyimide polymer matrix formed from one or more dianhydrides and one or more diamines; and
chemical functional groups disposed on a surface of the membrane, within pores of the membrane, within the bulk polymer matrix, or any combination thereof, wherein the chemical functional groups impart selective interaction with PFAS relative to inorganic anions.

2. The membrane of claim 1, wherein the chemical functional groups comprise quaternary ammonium groups.

3. The membrane of claim 1, wherein the chemical functional groups comprise amine functional groups selected from primary, secondary, tertiary, or quaternary amines.

4. The membrane of claim 3, wherein the amine functional groups comprise dopamine or polydopamine.

5. The membrane of claim 4, wherein the polydopamine coating is formed by oxidative polymerization of dopamine under alkaline conditions.

6. The membrane of claim 5, wherein dopamine hydrochloride is dissolved in a mixed solvent comprising water and tetrahydrofuran (THF).

7. The membrane of claim 6, wherein the mixed solvent comprises water and THF in a volume ratio between 3:1 and 5:1.

8. The membrane of claim 5, wherein tris(hydroxymethyl)aminomethane is added to adjust the dopamine solution to a pH between 8.0 and 9.0.

9. The membrane of claim 5, wherein the membrane is submerged in the dopamine solution for 8 to 24 hours and optionally aerated to promote uniform polymerization.

10. The membrane of claim 1, wherein the chemical functional groups comprise sulfonic acid groups incorporated into the polyimide backbone to form a sulfonated polyimide.

11. The membrane of claim 10, wherein the sulfonated polyimide comprises fluorophilic microphase-separated domains that preferentially interact with long-chain PFAS.

12. The membrane of claim 1, wherein the chemical functional groups comprise zwitterionic groups selected from sulfobetaines, carboxybetaines, or phosphobetaines.

13. The membrane of claim 1, wherein the polyimide polymer matrix comprises an electrospun nanofiber mat.

14. The membrane of claim 4, wherein the coated membrane is rinsed with deionized water and dried at a temperature between 30° C. and 60° C.

15. A method for removing per- and polyfluoroalkyl substances (PFAS) from an aqueous stream, comprising:
contacting the aqueous stream with a membrane according to any of claims 1-14; and
collecting a permeate having a reduced concentration of PFAS relative to the aqueous stream.

16. The method of claim 15, wherein the membrane selectively rejects PFOS and PFOA by at least 80% while rejecting chloride ions by less than 30%.

17. The method of claim 15, wherein the membrane is operated at a pressure between 0.5 bar and 3 bar.

18. The method of claim 15, wherein the aqueous stream comprises drinking water, groundwater, landfill leachate, industrial wastewater, or mining-impacted water.

19. The method of claim 15, further comprising regenerating the membrane by contacting it with a regeneration solution comprising a salt, an alcohol, or a combination thereof under conditions effective to desorb PFAS.

20. The method of claim 19, wherein the regeneration solution comprises 0.1-1.0 M sodium chloride or 10-30% methanol in water, and wherein the membrane retains PFAS rejection within ±5% of its initial performance after at least five regeneration cycles.
